(19) United States
(12) Patent Application Publication
(10) Pub. No.: US 2004/0039796 A1
(43) Pub. Date: Feb. 26, 2004

(54) Personalized cyber disk jockey and Internet radio advertising

(75) Inventor: Rodger Douglas Watkins, Austin, TX (US)

Correspondence Address: Docket Clerk, P.O. Drawer 800889, Dallas, TX, 75380, US

(73) Assignee: VIRTUAL RADIO, INC., Austin, TX (US)

(21) Appl. No.: 10/288,991

(22) Filed: Nov. 6, 2002

Related U.S. Application Data
(60) Provisional application No. 60/401,930, filed on Aug. 8, 2002.

(51) Int. Cl. G06F 15/16

(52) U.S. Cl. 709/218

(57) ABSTRACT

Streamed content is specifically directed to a target or listening device having a unique registered identifier associated with a stored profile. This unique stored connection profile, combined with the streaming process, sends a customized stream based on the stored profile information and, depending on the triggers within the stream designed to localize or regionalize the stream content, enables interaction with the listening device to deliver individualized stream elements, regional or group stream elements, and general (global) stream elements and/or other content conformed based on the stored profile information.

This application claims priority to U.S. provisional patent application No. 60/401,930 filed Aug. 8, 2002. The content of the above-identified application is incorporated herein by reference.

### TECHNICAL FIELD OF THE INVENTION

The present invention is directed, in general, to distribution of content and, more specifically, to personalized distribution of entertainment content and related advertising content.

### BACKGROUND OF THE INVENTION

Internet radio stations currently operate by streaming either a “rebroadcast” of a live event (i.e., a concurrent multicast of the radio transmission content over the Internet), a broadcast of a live event only on the Internet, or a series of content items streamed with commercials and pre-recorded messages. Any person at any location in the world may receive such broadcasts with the proper Internet connection, audio equipment and, in some instances, registration and/or subscription.

Within such systems, listeners around the globe hear advertisements from local advertisers purchasing a spot on, for example, a local radio station rebroadcast over the Internet. Such broad dissemination of advertising content does not necessarily benefit the local advertiser, where listeners in other states and countries are unlikely to patronize a remote restaurant or the like. Moreover, geographic market segmentation and pricing is undermined by such global transmission of advertising content.

There is, therefore, a need in the art for modifying broadcast methods to accommodate geographic variations in broadcast content and personalization of broadcast content.

### SUMMARY OF THE INVENTION

To address the above-discussed deficiencies of the prior art, it is a primary object of the present invention to provide, for use in a content broadcast system, a content streaming delivery system in which streamed content is specifically directed to a target or listening device having a unique registered identifier associated with a stored profile. This unique stored connection profile, combined with the streaming process, sends a customized stream based on the stored profile information and, depending on the triggers within the stream designed to localize or regionalize the stream content, enables interaction with the listening device to deliver individualized stream elements, regional or group stream elements, and general (global) stream elements and/or other content conformed based on the stored profile information.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIGS. 1A-1D depict content broadcast systems according to various embodiments of the present invention;

FIG. 2 illustrates content streams according to one embodiment of the present invention;

FIG. 3 depicts data structures employed in a content broadcast system according to one embodiment of the present invention;

FIGS. 4A-4E are data flow diagrams for a virtual radio content broadcast system according to one embodiment of the present invention;

FIGS. 5A-5G are user interface displays for an application enabling a user to receive a customized virtual radio stream from within a plurality of streams having global-local symmetry according to one embodiment of the present invention;

FIG. 6 depicts a data processing system including an application for receiving a customized virtual radio stream from within a plurality of streams having global-local symmetry according to one embodiment of the present invention;

FIGS. 7A-7D depict alternative views of a virtual radio system providing global-local symmetry according to various embodiments of the present invention.

### DETAILED DESCRIPTION OF THE INVENTION

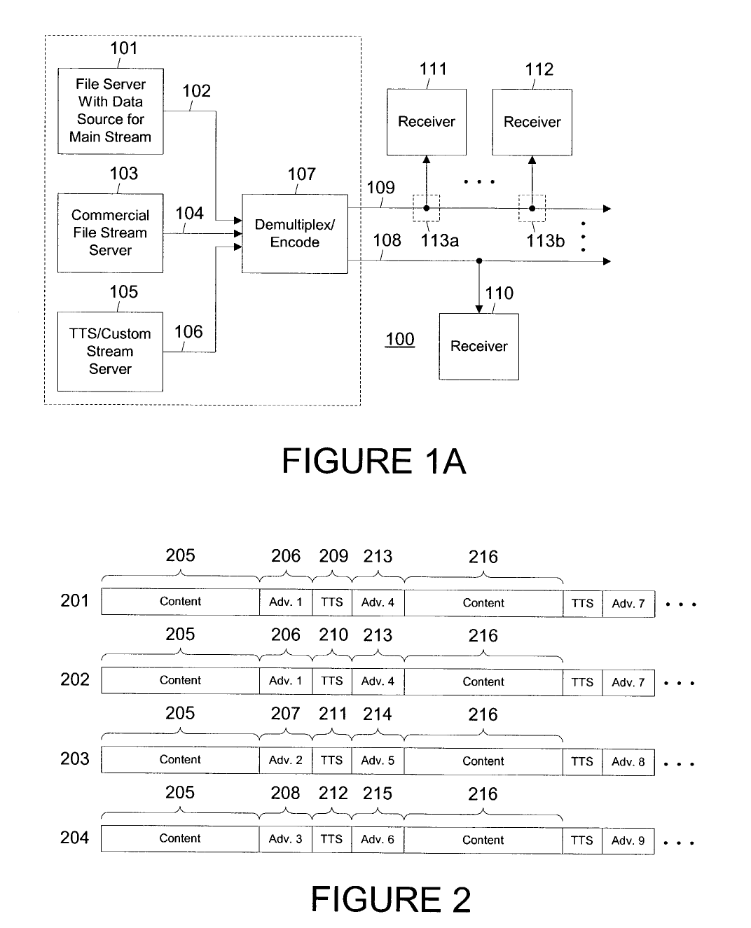

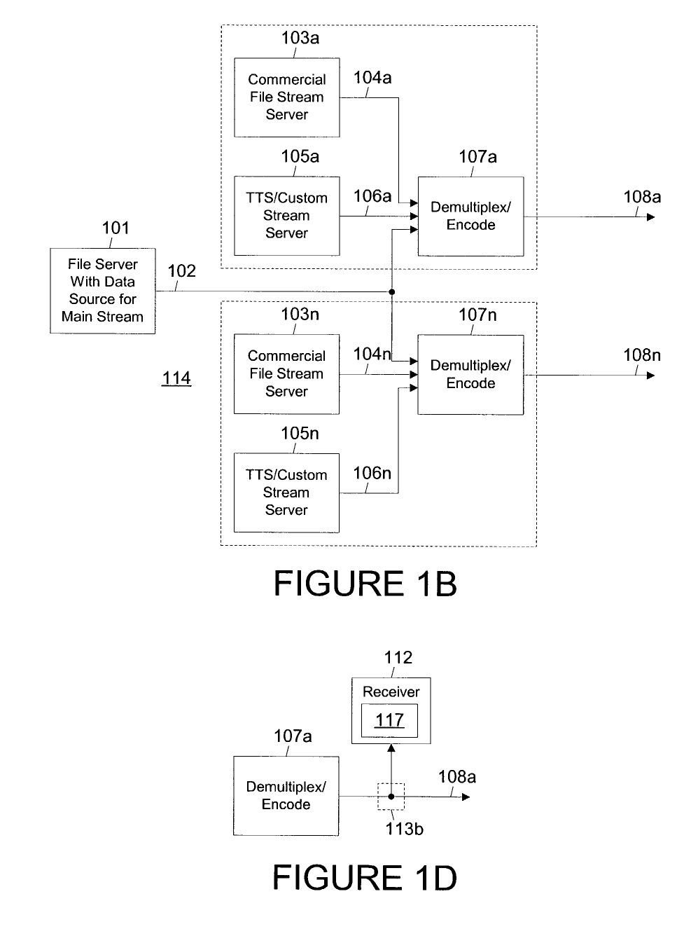

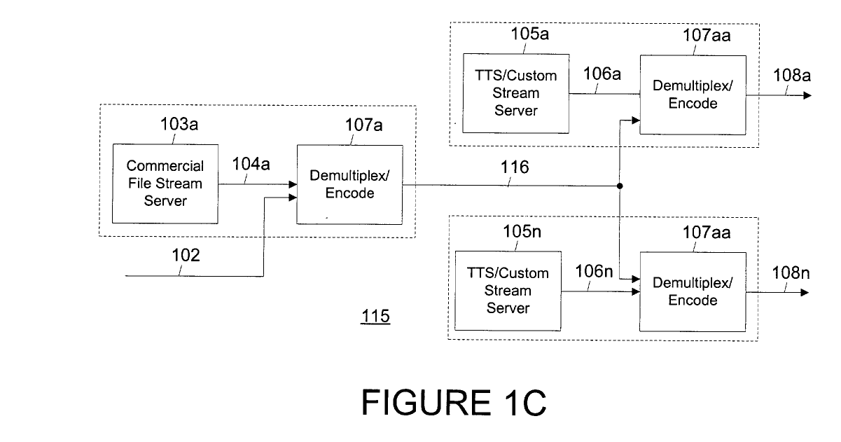

FIGS. 1A-1D through 7A-7B, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIGS. 1A through 1D depict content broadcast systems according to various embodiments of the present invention. The content broadcast system depicted may comprise an Internet broadcast system, a satellite, terrestrial or cable broadcast system, wireless mobile communications devices, or any other broadcast system in which individual receivers are registered or otherwise uniquely identified. Content broadcast system 100 may distribute audio content, combined audio/video content, HyperText Markup Language (HTML) pages or the like. While the exemplary embodiment described herein is an Internet audio (radio) broadcast system, the present invention is not limited to such systems. Accordingly, the content broadcast system(s) of the present invention may deliver content to computers, radios, televisions, wireless (mobile) telephones, personal digital assistants (PDAs), portable audio devices (e.g., MP3 players), or any combination thereof.

Content broadcast system 100 depicted in FIG. 1A includes a file server 100 functioning as a data source for a main data stream 102 of audio content, a commercial file stream server 103 containing commercial advertisements and providing a commercial data stream 104, and a text-to-speech (TTS) and/or custom content server 105 providing a personalized content data stream 106. As described in further detail herein, portions of the main data stream 102, the commercial data stream 104 and the personalized data stream 106 are selectively combined to form a plurality of different received data streams containing content varying by geographic location of the receiver and/or by the identity of the listener or viewer.

FIG. 2 illustrates content streams according to one embodiment of the present invention. Four content streams 201-204 are shown, each beginning with a common portion of entertainment content 205 (e.g., audio or audio/video) broadcast, received and played concurrently or synchronously within all four content streams. Two streams 201-202 are played for different listeners or viewers in different geographic regions, while the remaining two streams 203-204 are played for listeners or viewers in geographic regions different from that within which streams 201-202 are played and from each other. Accordingly, content 205 in streams 201-202 is followed by one advertisement 206 in streams 201-202, but by different advertisements 207-208 in streams 203-204, respectively. Advertisements 206-208 are received or played concurrently (or at least synchronously with preceding content) for each of the different listeners or viewers, with only one advertisement being played within the time segment shown within each stream. In this manner, advertising content may be targeted based on geographic location of the listener or viewer or other targeting method.

Each of the four content streams 201-204 are directed to, received by and played for different listeners or viewers. Accordingly, each stream 201-204 contains a TTS/custom content portion 209-212, respectively, which differs, at least to some degree, from the corresponding TTS/custom content portion within the remaining streams. Each TTS/custom content portion 209-212 may, for example, contain a TTS-generated audio message including the name of the listener or viewer (i.e., “John Smith” or “Sarah Jackson”). The TTS/custom content portions 209-212 may also include digitized voice recordings, where the recordings are generated in a single session and during editing segmented and identified for inclusion with particular streams. The TTS/customer content portions 209-212 are concurrently (or at least synchronously) played to each listener or viewer.

As illustrated, additional advertisements 213-215 and primary entertainment content portions 216 (as well as further TTS/custom content portions) may be synchronously added to the content streams 201-204 on an on-going basis.

It should be noted that while the time segments (e.g., segments 205, segments 206-208 or segments 209-212) are depicted as aligned for all receivers, in practice some variation is tolerable in the times at which play of various segments is initiated for different receivers, providing play of each segment is synchronous with play of preceding and subsequent segments (i.e., the segments form a substantially continuous stream). In particular, transmission delays may cause one receiver to play a particular segment slightly prior to or later than the time at which a geographically remote receiver initiates play of the same segment or a corresponding (counterpart) segment.

The present invention may be employed to produce a virtual radio broadcast in which the content is completely digital, a TTS system mimics a live disk jockey, and commercial advertisements are targeted on a geographic and/or individual basis. This produces global-local symmetry (GLS), in which general content is played globally to all listeners or viewers, different commercials are played to individual listeners or viewers or to specific groups of listeners or viewers, and particular, tailored messages are transmitted to individual listeners or viewers.

Referring back to FIG. 1A, a demultiplex/encode circuit or logic 107 receives the main data stream 102 from file server 100, commercial data stream 104 from commercial file stream server 103 and personalized content data stream 106 from TTS/custom content server 105, and produces one or more content data streams 201-204 for different receivers 110-112. In the example shown, file server 100, commercial file stream server 103, TTS/custom content server 105 and demultiplex/encoder 107 are co-located on the same server system or group of servers. These server(s) may generate an individual stream 108 for each specific receiver 110, or may generate a single stream 109 for a plurality of receivers 111-112. Optional switching devices 113a-113b (e.g., server applications, switches or routers) may control which portions of the combined stream 109 is received by each receiver 111-112, or the receivers 111-112 themselves may control which portions of the combined stream 109 are played to the listener/viewer.

FIG. 1B depicts an alternative configuration 114 of a content broadcast system including a single file server 101 providing the main data stream 102, but with a plurality of demultiplex/encoders 107a-107n each receiving different commercial data stream 104a-104n from separate commercial file stream servers 103a-103n, respectively, and different TTS/custom content data streams 106a-106n from separate TTS/custom content servers 105a-105n, respectively, to produce a plurality of streams 108a-108n. In this manner, customization of the content played at each receiver (not shown in FIG. 1B for simplicity) may be moved downstream within the broadcast process, to (for instance) geographically disbursed distribution servers.

FIG. 1C partially illustrates still another configuration 115 of a content broadcast system in which the customization of individual content streams (e.g., content streams 201-204) is moved still further downstream. In this embodiment, the main data stream 102 is combined with a single commercial data stream 104a from a designated commercial file server 103a (e.g., designated for a particular geographic region) by a demultiplex/encoder 107a. The output data stream 116 is distributed and separately combined with individual TTS/custom content streams 106a-106n by TTS/custom content servers 105a-105n by discrete demultiplex/encoders 107aa-107an to produce the individual content streams 108a-108n transmitted to different receivers (not shown).

FIG. 1D depicts yet another variant for a portion of a content broadcast system, which may be employed with any of the configurations depicted in FIGS. 1A-1C. In this embodiment, the part 117 of the TTS/custom content segments which is unique to individual listeners or viewers (e.g., the individual's name) is pre-stored within each respective receiver and played within the respective content stream in response to a trigger within that stream. In this manner, the TTS/custom content segments may be generalized regionally in a manner similar to advertisements (i.e., providing local weather traffic or news information) and individually tailored at the receivers.

It should be noted that the receivers described above may be audio (radio) or video (television) receivers, including satellite, cable or terrestrial wireless receivers, personal computers (clients or servers, with audio and/or video facilities), Internet appliances (set-top boxes, mobile telephones and wireless personal digital assistants (PDAs), IEEE 802.11 (“WiFi”) devices, etc. Any protocol or combination of protocols for transmitting data, including Transmission Control Protocol/Internet Protocol (TCP/IP), File Transfer Protocol (FTP), Media Streaming Broadcast Distribution (MSBD) protocol, User Datagram Protocol (UDP), Multimedia Messaging Service (MMS) and the like, including future protocols that will allow the present invention to operate.

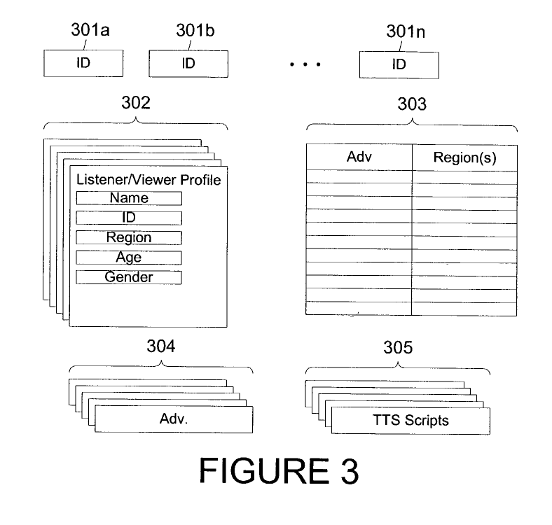

FIG. 3 depicts data structures employed in a content broadcast system according to one embodiment of the present invention. The present invention requires registration of listeners or viewers, who must log in to access the broadcast content stream. Unique identifiers 301a-301n are assigned to each registered listener/viewer; where a receiver allows multiple user profiles (e.g., a personal computer, set-top box, or television receiver), each registered individual receives a discrete identifier, which the listener/viewer may employ across multiple receivers of different types.

Each identifier 301a-301n is associated with a user profile with a user profile database 302. The user profiles are preferably centrally stored and indexed by identifier 301a-301n, which may be retrieved from a registered listener/viewer id database (not shown) during log in by the listener or viewer. Other demographic data may be stored in each user profile such as the listener's or viewer's name, the geographic region within which the listener/viewer is located (or most commonly located for mobile devices), and the listener's or viewer's age, gender, occupation, postal zip code, etc.

A table of advertisements and targeted geographic region(s) is also employed. The region specified within a user's profile may be employed to select advertising content inserted into each content stream, or other means (e.g., Internet Protocol address of the listener or viewer) may be employed. Databases 304 and 305 of advertising content and TTS scripts, indexed by identifiers, geographic regions, or both, are also employed in one embodiment of the present invention.

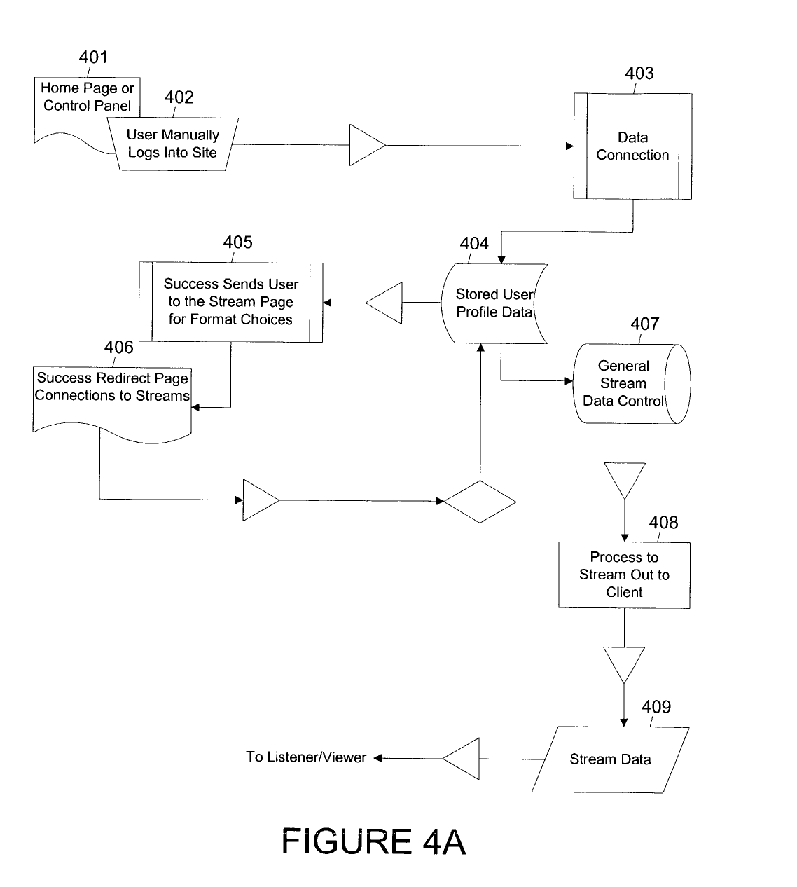

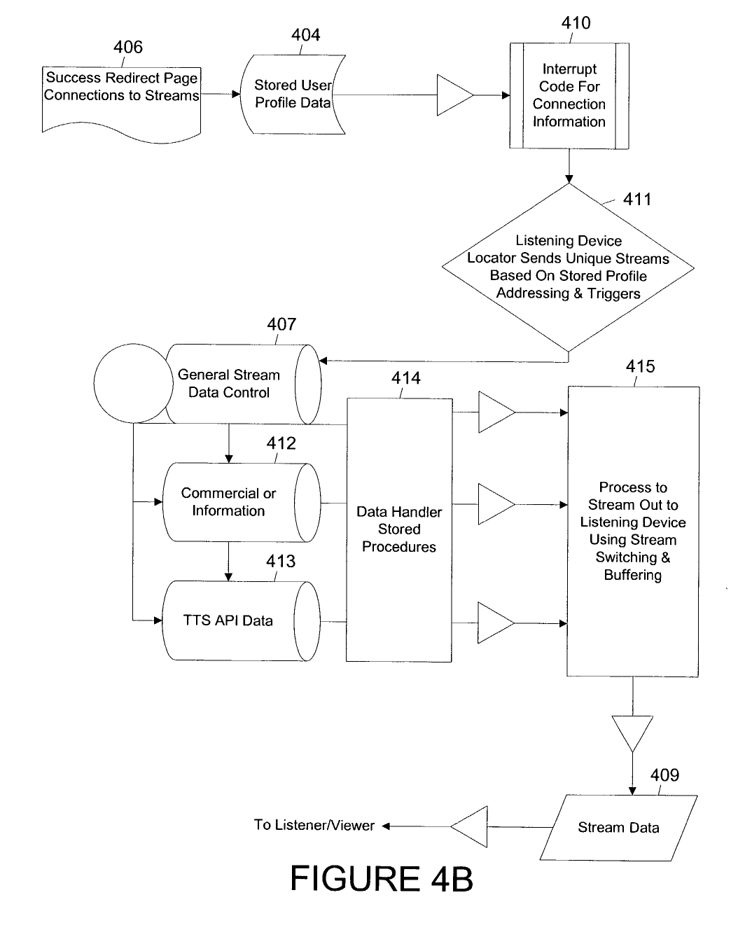

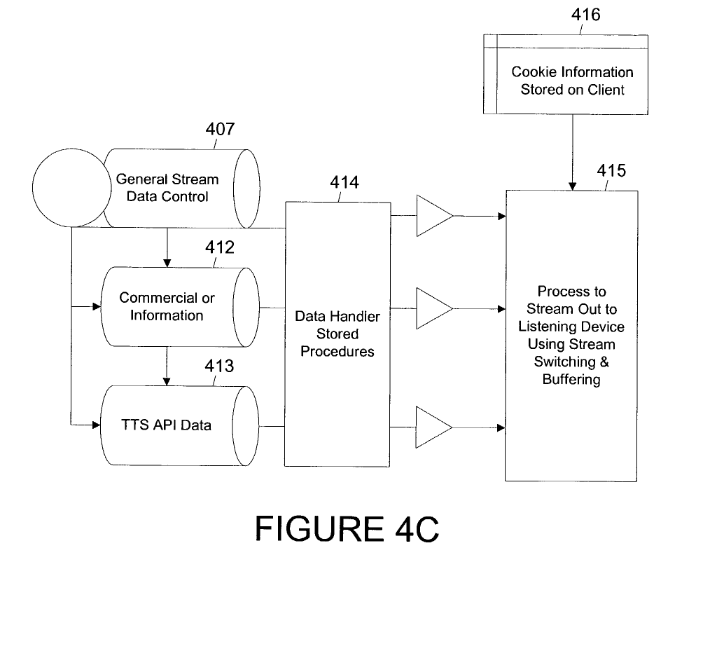

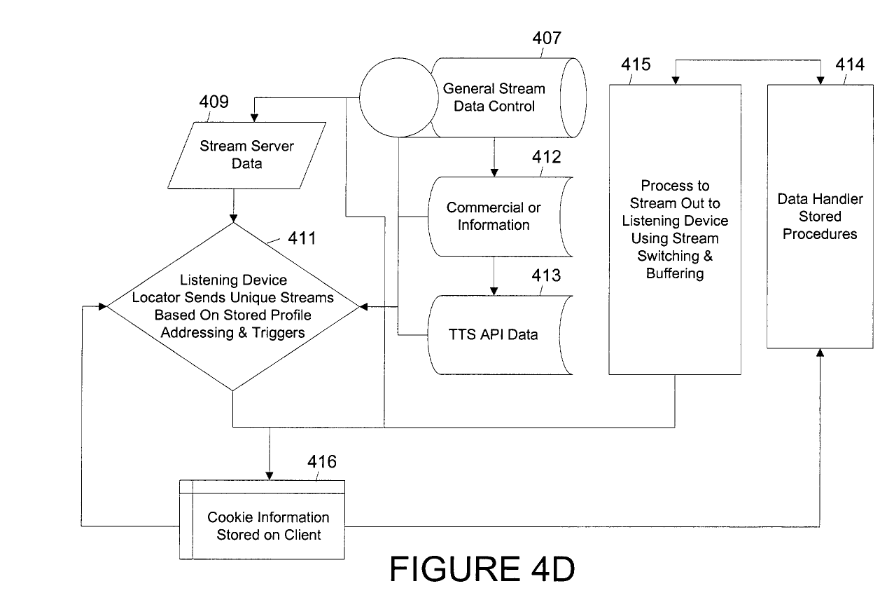

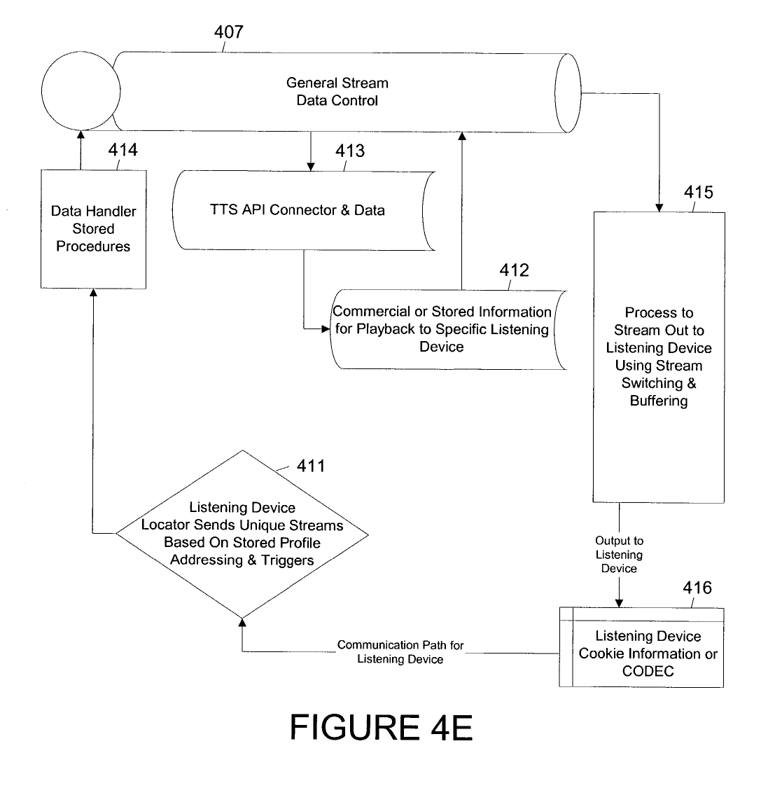

FIGS. 4A through 4E are data flow diagrams for a virtual radio content broadcast system according to one embodiment of the present invention. In FIG. 4A, a home page or control panel 401 containing a login interface 402 enables a listener or viewer to manually log in to a site for accessing virtual radio system (VRS) broadcast content. The login process creates a data connection 403 for the listener or viewer and, based on a stored user profile 404 for the listener or viewer, triggers a redirection 405 of the listener or viewer to a streams page 406 for format choices and connection to the streams. Upon selection of a format (e.g., Country, Rock, etc. for the exemplary embodiment of a virtual radio system) by the listener or viewer, the selection and relevant user profile data are transferred to a general stream data control 407 to initiate a process 408 for streaming content data 409 to the listener or viewer.

Referring to FIG. 4B, the general stream connection VRS switching system establishes, from a success redirect page 406 upon successful login, connections to the streams and sends the stored user profile data 404 through an interrupt code segment 410 for the stream connections to a listening device locator 411. Listening device locator 411 sends unique stream(s) to the general stream and data flow control 407 based on stored profile addressing and triggers. The general stream and data flow control 407 cascades streams through commercial or information stream source 412 to TTS API data source 413. General stream and data flow control 407, commercial or information stream source 412 and TTS API data source 413 each stream data to the data handler stored procedures 414, which generates streams to a process 415 to be streamed out as stream data 409 to the listening device via stream switching and buffering.

General stream and data flow control 407 is designated stream #1 and is the first stream all listening devices connect to after successful login, and also the default for failed login as well. Elements within this stream trigger events such as commercial message breaks connection (stream #2) and TTS API connection (stream #3) to be made to the listening devices. The general stream and data flow control 407 is controlled by a database that stores MP3's, WAVs and other music file types, although it is understood that the content and file types are irrelevant and that this stream is controlled by the database and stored procedures. When using a customized system for music or content play, the general stream and data flow control 407 is a generic method for playing music and/or other content to a listening device.

One example usage of the general stream and data flow control 407 is for fifteen output streams, where each stream carries a different music format (country, rock, etc.). A listening device connects to one of the streams at the discretion of the user; the general stream is already running on the server in the background, and all users pick up the same output per stream format. The general stream contains embedded tones, dynamic code triggers and other methods placed in the stream to activate stream switches for commercial breaks and the TTS API connector and data. As a result, the virtual radio steam is actually unique to the listener where the TTS cyber digital jockey (DJ) and commercials are concerned, although every listener gets the same music at the same time per the streamed music format.

The process 408 to stream out to client involves any streaming server technology that facilitates stream switched outputs and stream switching so that the transitions are synchronized with the VRS. The TTS voices mimic a live DJ and the commercials target each PC user or listener.

Referring to FIG. 4C, the VRS process is preferably initially controlled by cookie information 416 stored on the client to control the stream generation process 415 or, equivalently, by a coder/decoder (CODEC) module or unit or a dynamic link library (DLL). As shown in FIG. 4D, cookie information 416 is employed by the data handler stored procedures 414 to selectively control the process 415 to stream out to the client. The data handler stored procedures 414 on the source server are processes used in conjunction with the process 415 and the listener device locator sending a unique stream based on the stored profile 411. The listening device cookie info, or a codec 416, stores either pre-downloaded commercials that will be prompted to play at certain times encoded and/or prebuilt into the stream. These prompts are activated by the users stored information, with addressing and triggering occurring from the information contained in the data store.

FIG. 4E illustrates a process specific to stream switching in which listening device locator 411 triggers the data handler stored procedures 414 to generate a sequential stream data output 417 cycling through the general or main stream 418 switching to the TTS API connector and data 419 and then to a commercial or stored information 420 for playback to a specific listening device.

With the present invention, a local advertiser can purchase an advertisement sent specifically to users or listening devices meeting specific criteria such as location, age, gender, or region. More advertisements per station may be played, and more accurate tracking and demographic information may be collected. GLS and VRS provide the required elements to localize a station stream and a platform for point of advertisement sales (POAS) capabilities, directing personalization handshakes between the server and the listening device.

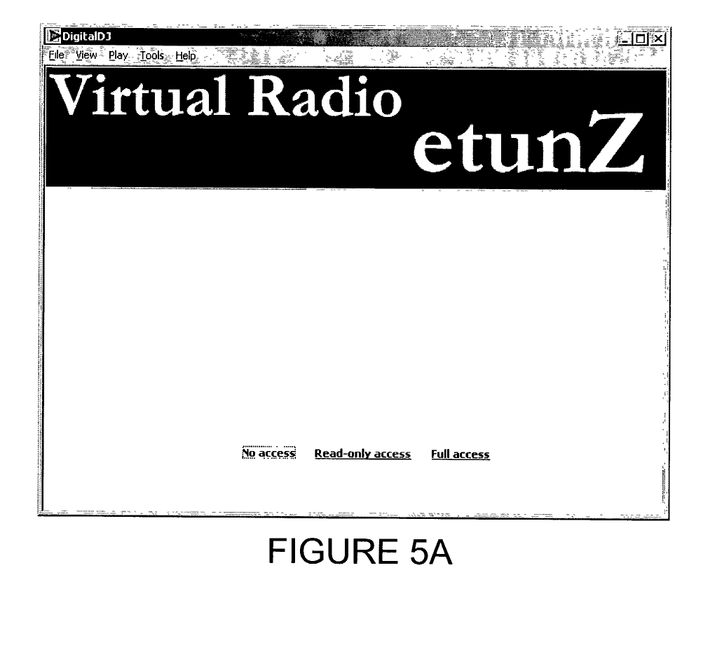

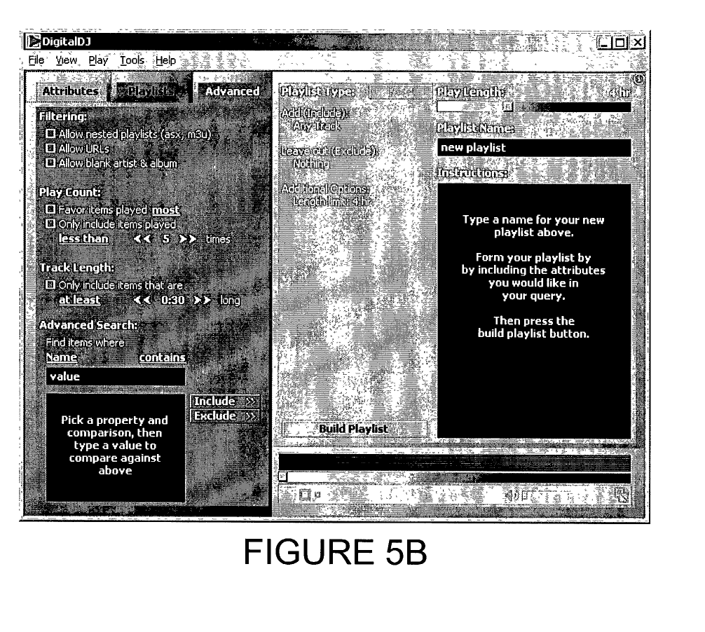

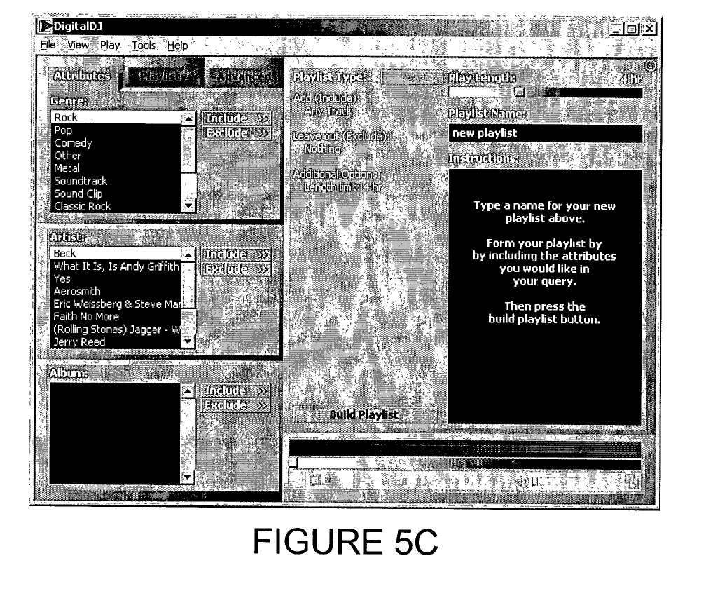

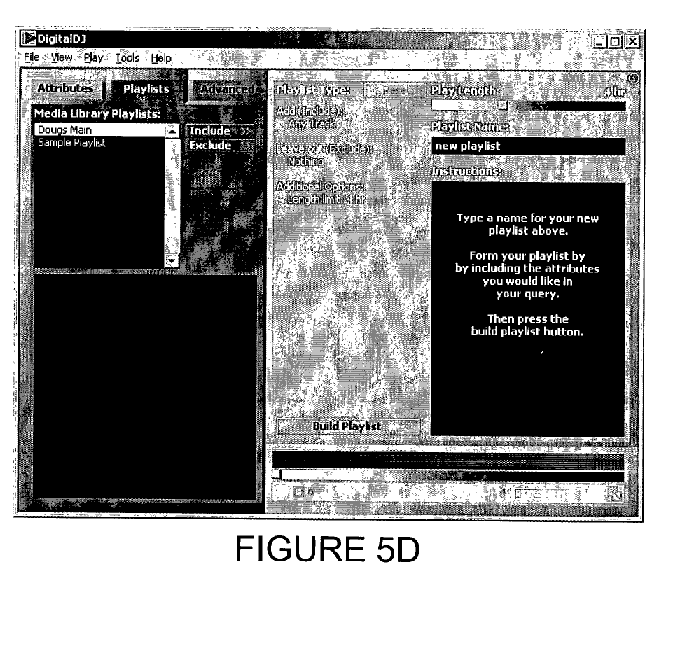

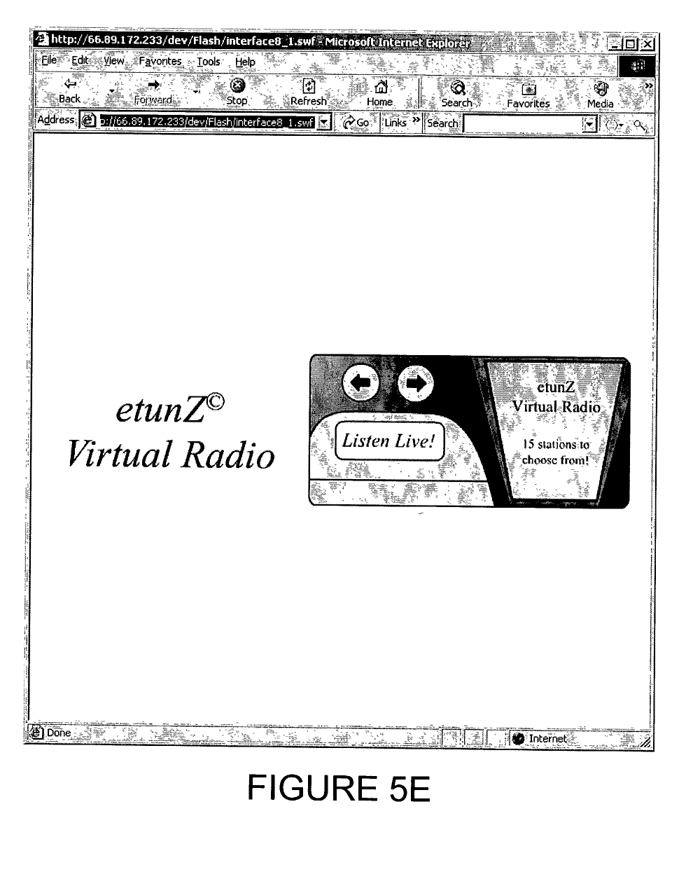

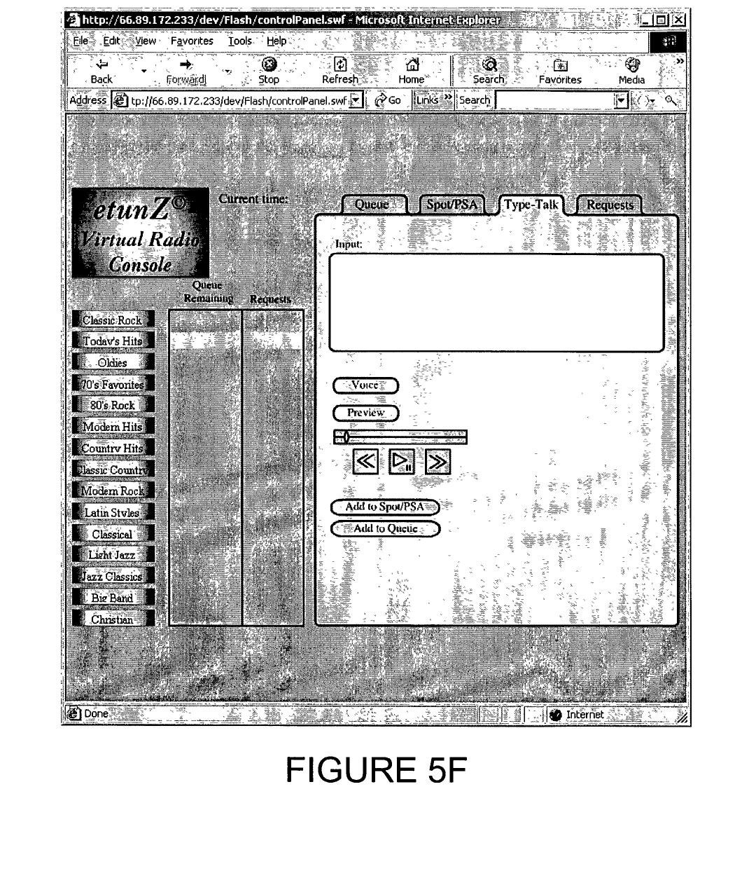

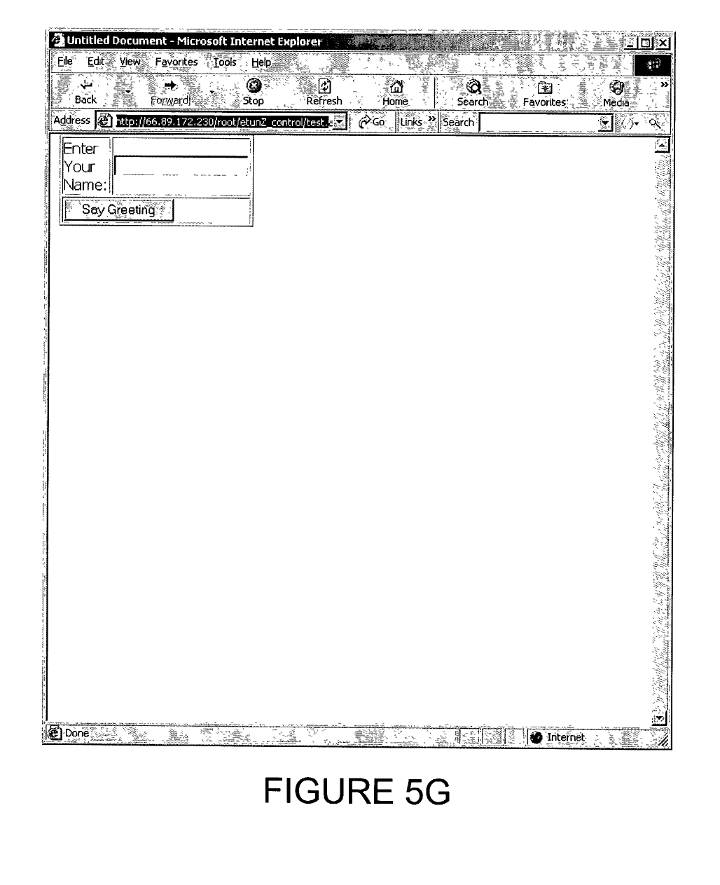

FIGS. 5A through 5G are user interface displays for an application enabling a user to receive a customized virtual radio stream from within a plurality of streams having global-local symmetry according to one embodiment of the present invention. In the exemplary embodiment, the virtual radio system is implemented utilizing Windows Media Player “skins” (overlaid plug-ins changing the user interface displays of the underlying program), although other suitable implementations are possible. FIG. 5A is an initial splash screen for accessing the customized virtual radio stream as described above, while FIG. 5B is a view of a control panel illustrating how a user's profile is formed. FIG. 5C is a playlist showing the available music from which a content editor may create individual customer's stations, while FIG. 5D illustrates that the play list then becomes a customer profile stored in the VRS database (either remotely or distributed locally and remotely). FIGS. 5A-5D are user interface diagrams relating to constructing the VRS and database.

FIG. 5E is user interface display illustrating a sample presentation of music choices accessible to the public. User interface controls (the arrows) allow the user to select from among various available stations, with a current selection shown in a display area (initially stating “150 stations to choose from!”). Another user interface control (“Listen Live!”) allows the user to access the currently selected station.

FIG. 5F is a control page where the user tests the spelling of names and sentences using the TTS generator, while FIG. 5G is a prototype box in which a name or phrase may be typed, then stored in a database from which it will be played back as a voice message on a user's system through the web browser or media player application.

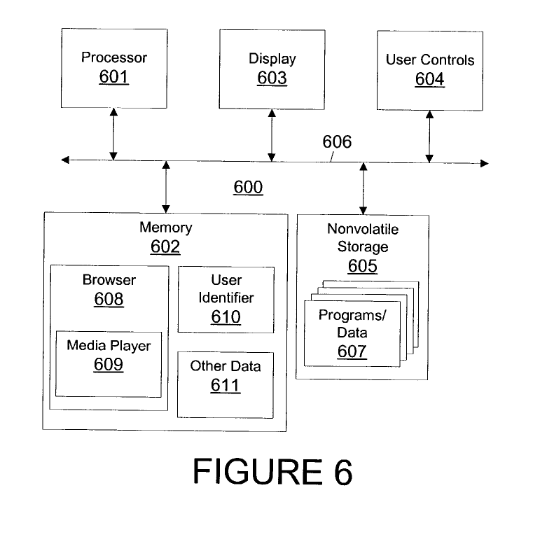

FIG. 6 depicts a data processing system including an application for receiving a customized virtual radio stream from within a plurality of streams having global-local symmetry according to one embodiment of the present invention. (“Radio,” as used herein, includes audio transmitted on selected channels within a video broadcasting system—e.g., music channels in a satellite broadcast system). Data processing system 600 includes: at least one processor 601; memory 602, which may include read only memory (ROM), random access memory (RAM), cache memory, graphics card memory, etc.; at least one display 603; user controls 604, such as a keyboard and a mouse, trackball or similar device; and nonvolatile storage 605, such as a hard disk drive (either local or on a remote network node) as well as, optionally, a read-write optical disk drive.

Processor 601, memory 602, display 603, user controls 604 and nonvolatile storage 605 are all coupled by an interconnect 606, such as one or more buses and/or a network connection, and are interoperable. Data processing system 600 is constructed and operates according known techniques, including a basic input/output system (BIOS), and operating system (OS), and one or more applications or user programs.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 600 may conform to any of the various current implementations and practices known in the art.

Nonvolatile storage 605 conventionally contains a variety of user programs and user data 607, where the user programs are loaded into memory 602 for execution and the user data (e.g., cookies) may be employed in customizing the operation of such user programs. In the present invention, programs 607 include a browser 608 or similar application within which a media player 609 (e.g., Windows Media Player, Quicktime, or the like) operates as a plug-in. A user identifier 610 is employed to customize the VRS stream that this receiver 600 receives over the stream received at other, similar receivers. In addition, other data 611, such as the listener's profile (e.g., age, gender, race, etc.), may be stored within the receiver 600 rather than in a remote data store, and employed locally to customize the received stream (e.g., by selecting from a plurality of commercials targeting the listener's geographic location).

One of the invention's primary uses it to increase functionality of existing systems to produce a completely digital VRS stream that may be dynamically directed in many different directions to many different targeted listening devices. Overall, the present invention offers enterprises unique streams that target their clients for a value added service.

The results of such on-demand combination of the virtual radio stream with a data source to the end user are illustrated by the following examples: In retail application, retail store chains may attached a listening device to the in-store background audio at each store, and use the invention to distribute custom advertising and TTS DJ announcements at each listening location using the connection profile. Each retail store would therefore have the ability to play unique commercials and announcements at their location, with the system intercepting cues and triggering advertisement or announcement placement within each unique stream.

By converging technologies using TTS and dynamic audio streaming, together with a virtual station operating like a tradition commercial radio station, one of the initial uses of virtual radio takes advantage of completely digital events such as DJ that are digital TTS-generated voices playing from a source system. Current TTS web enabled systems are available, but the systems in use are only designed to dynamically create TTS audio files for a TCP/IP audio download. With the present invention, the TTS stream is created and sent to the end user as a dynamic stream formatted file, so that the virtual radio content becomes localized as the source interacts digitally with the user. Unique uses for advertising and messaging result since the digital voice can either address an audience as a group, address sub-groups separately, or distinctly address individual audience members independently (and even by name).

Simply stated, a virtual radio stream addresses the client listener based on a first (and last) name basis, as well as based on postal zip code, region or other demographic category stored on a data source to assist in isolating and targeting a listener or group of listeners. The initial uses of VRS GLS—or virtual television video system (VTVS) GLS—provide the opportunity to promote virtual radio/TV as a local market station and a solution to current industry problems.

With the present invention, the TTS digital jockey (DJ) speaks directly to the listeners/viewers based on scripts with personalization fields—e.g., “John Smith, thank you for listening to etunZ” and “Sarah Jackson, thank you for listening to etunZ”. With these types of message scripts, the DJ is able to simultaneously personally address thousands of individual listeners/viewers logged into the system. In addition, different scripts may be concurrently employed for different listeners or listener groups—e.g., “John Smith, thank you for listening to etunz” but “Sarah Jackson, you've won a trip for two to Jamacia!” Targeted commercial messages are thereby directed to specific audience members. Unique localized commercial messages are sent to listeners (or users) on an individual basis based on predetermined criteria applied to each user profile within the data source.

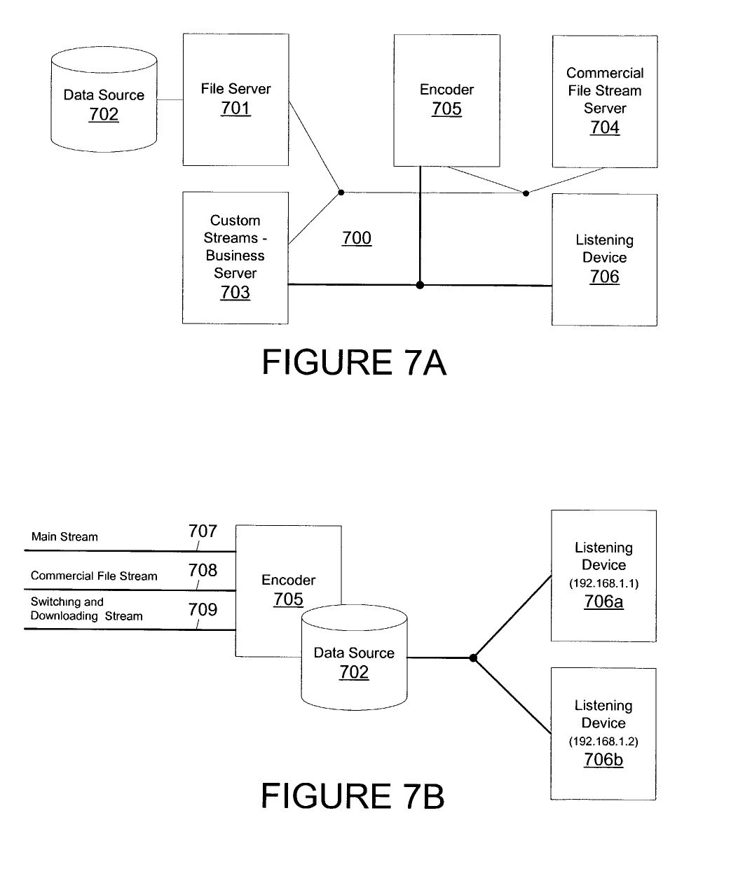

FIGS. 7A-7D depict alternative views of a virtual radio/TV system providing global-local symmetry according to various embodiments of the present invention. In the implementation of FIG. 7A, a file server 701 with the data source 702 is coupled to a custom streams/business server 703, a commercial file server 704 and an encoder 705. The encoder produces the virtual radio streams with switching codes, which are distributed via a separate data path coupled to a listening device 706 and the custom streams/business server 703. The virtual radio stream played by the listening device 706 is switched between the stream from encoder 705 and custom streams/business server 703.

In the embodiment of FIG. 7B, the encoder 705 receives the main stream 707 and commercial file stream 708 together with a switching and download stream 709, and produces streams buffered through data source 702. The streams delivered to listening devices 706a and 706b are switched by tone or code switch/trigger, and include switching to a TTS voice to target users profile information and, through a commercial switch mechanism, to target messages for the listener or group to which the listener belongs. Each IP address hears separate file stream commercials while maintaining a server connection that switches the streams to provide virtual streams to multiple locations.

It should be noted that the communication processes shown may be readily reversed and employed with speech to text (STT) to enable verbal introduction of commands to the receiver (e.g., query, file open, file close, as well as other commands) with the TTS/STT system performing the corresponding function and/or returning responsive information.

The present invention allows personalized TTS message(s) to be dynamically inserted within a broadcast or multicast stream, sent to a specific listening device or each of a group of listening devices meeting selected criteria and connected to the broadcast (or multicast) stream. In addition, commercial messages from a separate stream source are switched into the broadcast or multicast stream, streamed or played only to a listening device meeting selected criteria or to a group of listening devices meeting the selected criteria. Listener tracking and collection of demographic and streaming-specific information may be performed for each listening device or unique connection. Use of TTS allows dynamic “speech” of information such as an individual's name, addressing them directly as if in a conversation, together with other text or prerecorded content (including an electronic mail message) dynamically generated or switched into the stream sent to a receiver or listening device, such as alerts, messages, and announcements (e.g., enterprise event calendar messages). In addition, TTS allows text-based content such as electronic mail message text and web site content (such as sole source authorities of content including, for instance, the Library of Congress) to be “read” to the listener. TTS may be utilized alone or in combination with digitized recordings of the type currently used in digital FM broadcasts.

A virtual radio station may thus be operated mimicking existing standards and content, but including value added features due to the streams being localized/regionalized and personalized. The client may manage and manipulate content using a control panel for the listening device, if applicable. Demographic information and stream session information, as well as the Internet browsing history on the listening device, may be employed to enable an advertiser or user to dynamically target listening devices with customized content unique to the customer or listener.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A system for content delivery comprising:
one or more content delivery servers automatically delivering content to a stream transmitted to each of a plurality of receivers, wherein the stream comprises two or more of:
a main stream portion delivered globally to each of the receivers;
a group varying stream portion delivered to each receiver within a plurality of groups of receivers, wherein content delivered to each receiver within the group varying stream portion differs for each group of receivers; and
a personalized stream content portion delivered to each receiver and containing content customized for each particular receiver.

2. The system according to claim 1, wherein the stream transmitted to each receiver comprises each of the main stream portion, the group varying stream portion, and the personalized stream portion.

3. The system according to claim 1, wherein the group varying stream portion contains content depending on a geographic location of the receiver to which the stream is transmitted.

4. The system according to claim 1, wherein the personalized stream content portion includes text-to-speech (TTS) content derived from a script.

5. The system according to claim 4, wherein the scripts employed for the personalized stream content portion delivered to two different receivers are completely different.

6. The system according to claim 1, further comprising:
a first receiver within a first group of receivers within the plurality of groups of receivers receiving, from the one or more content delivery servers, the main stream portion, a first group varying stream portion, and a first personalized stream portion;
a second receiver within the first group or receivers receiving, from the one or more content delivery servers, the main stream portion, the first group varying stream portion, and a second personalized stream portion different from the first personalized stream portion; and
a third receiver within a second group of receivers within the plurality of groups of receivers receiving, from the one or more content delivery servers, the main stream portion, a second group varying stream portion different from the first group varying stream portion, and a third personalized stream portion different from the first and second personalized stream portions.

7. The system according to claim 1, further comprising:
a plurality of receivers registered and connected to receive content from the one or more content delivery servers and including at least one receiver from each of the plurality of groups of receivers, wherein:
each receiver within the plurality of receivers receives identical content within the main stream portion,
each receiver within one of the groups of receivers receives identical content within the group varying stream portion and receivers within different groups of receivers receive different content within the group varying stream portion, and
each receiver receives different content within the personalized stream content portion.

8. A method of content delivery comprising:
delivering content from one or more content delivery servers to a stream transmitted to each of a plurality of receivers, wherein the stream comprises two or more of:
a main stream portion delivered globally to each of the receivers;
a group varying stream portion delivered to each receiver within a plurality of groups of receivers, wherein content delivered to each receiver within the group varying stream portion differs for each group of receivers; and
a personalized stream content portion delivered to each receiver and containing content customized for each particular receiver.

9. The method according to claim 8, wherein the stream transmitted to each receiver comprises each of the main stream portion, the group varying stream portion, and the personalized stream portion.

10. The method according to claim 8, wherein the group varying stream portion contains content depending on a geographic location of the receiver to which the stream is transmitted.

11. The method according to claim 8, wherein the personalized stream content portion includes text-to-speech (TTS) content derived from a script.

12. A machine usable stream containing content from one or more content servers and delivered to each of a plurality of receivers, wherein the stream comprises two or more of:
a main stream portion delivered globally to each of the receivers;
a group varying stream portion delivered to each receiver within a plurality of groups of receivers, wherein content delivered to each receiver within the group varying stream portion differs for each group of receivers; and
a personalized stream content portion delivered to each receiver and containing content customized for each particular receiver.

13. The stream according to claim 12, wherein the stream comprises each of the main stream portion, the group varying stream portion, and the personalized stream portion.

14. The stream according to claim 13, wherein the group varying stream portion contains content depending on a geographic location of the receiver to which the stream is transmitted.

15. The stream according to claim 13, wherein the personalized stream content portion includes text-to-speech (TTS) content derived from a script.

16. The stream according to claim 15, wherein the scripts employed for the personalized stream content portion delivered to two different receivers are completely different.

17. An Internet radio broadcast system comprising:
a main stream delivery server;
a commercial file stream server;
a custom stream server; and
an encoder receiving content streams from each of the main stream delivery server, the commercial file stream server and the custom stream server, the encoder generating, from the received streams, a plurality of delivery streams for transmission to each of a plurality of receivers, wherein each delivery stream comprises:
a main stream portion delivered globally to each of the receivers;
a group varying stream portion delivered to each receiver, wherein the receivers are logically divided into groups and the content delivered to each receiver within the group varying stream portion differs for each group of receivers; and
a personalized stream content portion delivered to each receiver and containing content customized for each particular receiver.

18. The system according to claim 17, wherein the group varying stream portion contains content depending on one or more of:
a geographic location of the receiver to which the stream is transmitted;
a music format selected for content within the main stream portion; and
an age, gender, personal preference or other demographic attribute within a user profile associated with the receiver to which the stream is transmitted.

19. The system according to claim 17, wherein the personalized stream content portion includes text-to-speech (TTS) content derived from a script and including a name within a user profile associated with a receiver to which the stream is transmitted.

20. The system according to claim 17, wherein the main stream portion contains audio from a user-selected music format selected from a plurality of music formats each corresponding to one of the delivery streams.
